(19) United States
(12) Patent Application Publication
(10) Pub. No.: US 2008/0117021 A1
(43) Pub. Date: May 22, 2008

(54) METHOD OF PLACING AND USING AN ELECTRONIC IDENTIFICATION TRANSPONDER

(76) Inventor: Kevin Michael Brunski, Crown Point, IN (US)

Correspondence Address: HARTMAN & HARTMAN, P.C., 552 EAST 700 NORTH, VALPARAISO, IN, 46383, US

(21) Appl. No.: 11/943,033

(22) Filed: Nov. 20, 2007

Related U.S. Application Data
(60) Provisional application No. 60/866,531, filed on Nov. 20, 2006.

(51) Int. Cl. G05B 19/00

(52) U.S. Cl. 340/5.81; 340/10.1

(57) ABSTRACT

A method for identifying individuals. The method entails identifying a human with an electronic identification transponder that can be interrogated by and communicate with a separate reader unit while the transponder is implanted in a surface region of a dental structure, namely, a mammalian tooth, denture, or dental prosthesis. The reader unit is used to interrogate the transponder, read an identification number stored by the transponder, and read additional information from the transponder associated with the person in which the transponder is implanted.

### CROSS REFERENCE TO RELATED APPLICATIONS

This application claims the benefit of U.S. Provisional Application No. 60/866,531, filed Nov. 20, 2006, the contents of which are incorporated herein by reference.

### BACKGROUND OF THE INVENTION

The present invention generally relates to electronic identification methods and devices. More particularly, this invention relates to a technique for the preparation, placement, and closure of a transponder in a tooth or dental prosthesis, and the use of such a transponder for identification purposes.

Transponders and particularly radio frequency identification (RFID) tags and chips (microchips) have been employed to identify products, inventory and various other inanimate objects, and living beings including pets and livestock. For use in product and inventory identification, RFID microchips are typically relatively large in size and mounted to an adhesive strip for application to the objects of interest. When interrogated by a reader unit, the microchip transmits a signal that uniquely identifies the object. For use in animals, RFID microchips are typically encapsulated and placed beneath the skin by injection. Such RFID microchips are typically small, such as about one millimeter in length and about one millimeter in diameter, and can be coded with up to ten digits to uniquely identify the animal. A commercial example of such an RFID microchip is sold under the name AVID® by Avid Marketing, Inc., Norco, Calif. USA.

Because RFID microchips have the undesirable potential to migrate when implanted subdermally, their use with humans has not been widely accepted or practiced. However, if transponders could be securely placed in a manner that eliminates migration, their use for human identification could become more widely practiced, particularly for children, the elderly, and others whose age, mental capacity, or other physical or mental status puts them at risk of being lost, abducted, etc. Furthermore, the use of transponders could find use in other scenarios, such as to identify members of the armed services.

### BRIEF SUMMARY OF THE INVENTION

The present invention provides a method for identifying individuals, and involves the preparation, placement, and closure of an electronic identification transponder in a tooth, denture, or dental prosthesis.

More particularly, the method entails identifying a human with an electronic identification transponder that can be interrogated by and communicate with a separate reader unit while the transponder is implanted in a surface region of a dental structure, namely, a mammalian tooth, denture, or dental prosthesis. According to a preferred aspect of the invention, the reader unit is used to interrogate the electronic identification transponder, read an identification number stored by the electronic identification transponder, and read additional information from the transponder associated with the person in which the transponder is implanted.

In view of the above, the present invention provides a secure, non invasive, and confidential method for instantaneously retrieving identification and potentially other information concerning a person into which the transponder is implanted. Such information can be vital to identify persons in a variety of emergency and nonemergency situations. Furthermore, the transponder can be present without visual detection by uninformed parties, such that unauthorized removal of the transponder is not likely to occur. Finally, the transponder can be permanent if so chosen, yet removable by a skilled technician without causing pain or permanently disfiguring the individual.

Other objects and advantages of this invention will be better appreciated from the following detailed description.

### BRIEF DESCRIPTION OF THE DRAWINGS

FIGS. 1A through 1E schematically depict human Tooth #30 (facial aspect) and a procedure for placing a transponder in Tooth #30 in accordance with an embodiment of this invention.

FIGS. 2A through 2F schematically depict human Tooth #3 (lingual aspect) and a procedure for placing a transponder in Tooth #3 in accordance with an embodiment of this invention.

FIGS. 3A through 3E schematically depict human Tooth #31 (facial aspect) and a procedure for placing a transponder in Tooth #31 in accordance with an embodiment of this invention.

FIGS. 4A through 4E schematically depict human Tooth #2 (lingual aspect) and a procedure for placing a transponder in Tooth #2 in accordance with an embodiment of this invention.

FIG. 5 schematically represents a scanner suitable for intra-oral interrogation of the transponders placed as shown in FIGS. 1A-1E, 2A-2E, 3A-3E, and 4A-4E.

FIG. 6 schematically represents a scanner suitable for extra-oral interrogation of the transponders placed as shown in FIGS. 1A-1E, 2A-2E, 3A-3E, and 4A-4E.

FIG. 7 schematically represents an implantable RFID tag suitable for use as the transponder for the present invention.

### DETAILED DESCRIPTION OF THE INVENTION

The present invention makes use of transponders that are sufficiently small to permit their implantation in a human dental structure, such as certain locations on certain human teeth. Placement on dental structures is particularly selected to facilitate implantation, be accessible for interrogation and communication with a separate reader unit, and reduce the risk that the transponder will be damaged or interfere with the bearer's normal behavior. For this purpose, the transponder is preferably not larger than about one millimeter in width by about six millimeters in length, and is carried on a pliable substrate to have a thickness of less than four millimeters, more preferably less than one millimeter. The transponder is sufficiently small to also be placed in a denture or partial denture. Preferably, once placed the transponder is registered to the particular individual by entering or registering a personalized multi-digit identification code. The transponder can also be encoded to provide certain information concerning the individual, such as the individual's medical history. As an example, the identification code could be or include the individual's social security number, and may contain data or be associated with a database that contains portions or all of the individual's medical history. The transponder can be scanned by the reader unit, which is preferably adapted to interrogate the transponder and, optionally, program the transponder.

A preferred transponder is an ultrahigh frequency (UHF) RFID tag or chip (microchip), such as an RFID tag commercially available from Lutronic International under the name NONATEC®. According to Lutronic International literature, the NONATEC® tag utilizes an electronic chip from Philips Research. In contrast to conventional silicon-chip-based RFID tags, the Philips chip is understood to be a fully functional 13.56 MHz RFID chip printed directly onto a plastic substrate along with an antenna. For illustrative purposes, FIG. 7 represents such a chip 12 printed on a plastic substrate 14 with an antenna 16, all of which are encapsulated on the substrate 14 to form an RFID tag 10. In addition to being very small, generally on the order of about one millimeter in diameter and about six millimeters in length, the NONATEC® RFID tag is capable of recognizing up to 512 characters (bytes), and is therefore well suited for not only storing a personalized multi-digit identification code, but also store additional information concerning an individual, such as the individual's medical history.

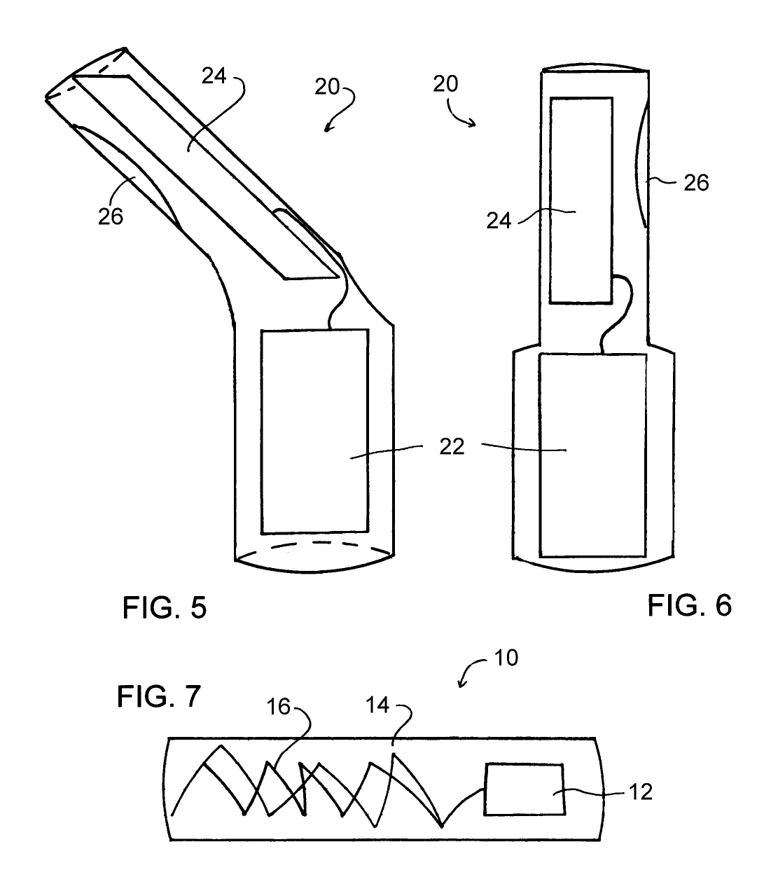

The tag 10 is not required to be self-powered, but instead is preferably capable of transmitting and receiving data when interrogated by a reader/writer unit. Intra-oral and extra-oral reader/writer units 20 are schematically represented in FIGS. 5 and 6. Each reader/writer unit 20 is represented as being equipped with an RFID transceiver 22, circuitry 24, and a readout 26 that displays the identification number of the tag 10 when interrogated with the reader/writer unit 20. The reader/writer units 20 can be equipped with an internal battery, and/or can be powered by being plugged into a computer (such as through a USB port) or other power source. Commercial examples of suitable reader/writer units include those also available under the name NONATEC® from Lutronic International. A handheld version is referred to as the NONATEC® Reader/Writer Device, while a hands-free bench-mounted version is referred to as the NONATEC® BLUETOOTH® Lab Bench Reader/Writer Device. Both devices operate at about 13.56 MHz, and are capable of reading and writing to RFID plastic cards containing 512 bytes of information. Furthermore, both devices come with software that facilitate the programming and interrogation of NONATEC® RFID tags, including tag identification, data retrieval, and data writing, as well as categories of information stored on the tags or associated with the tag identification number.

In investigations leading up to this invention, the NONATEC® transponders and reader/writer units noted above were shown to perform well for the intended application, including the capability of interrogation and communication through the cheek of the individual. Nonetheless, it is foreseeable that other transponders and reader/writer units operating at various other frequencies could be used. For example, an RFID transponder disclosed in U.S. Pat. No. 5,559,507 could potentially be used. Furthermore, it is foreseeable that various functionalities could be incorporated into the tag 10, including a global positioning system (GPS) capability.

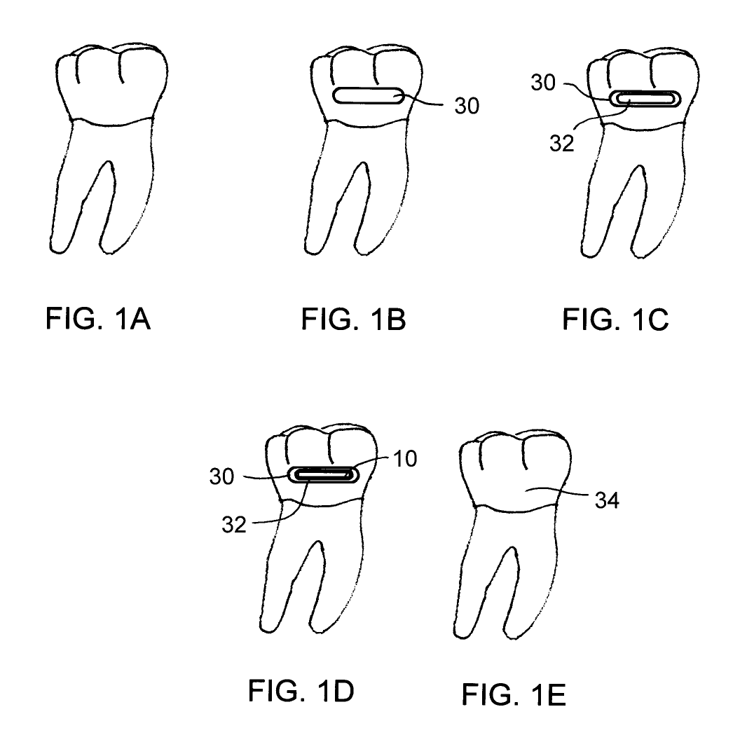

While the NONATEC® RFID tag is adapted to be placed subdermally in animals by injection, the present invention places the tag 10 in a human (mammalian) tooth, as schematically represented in FIGS. 1A-1E, 2A-2E, 3A-3E, and 4A-4E. A key aspect of the invention is the ability to place a transponder in a location that is unobtrusive, visually undetectable, permanent if so chosen, yet removable by a skilled technician without causing pain or permanently disfiguring the individual. Based on these criteria, the present invention proposes the placement of the tag 10 in prioritized sites on certain teeth, which are identified herein in reference to tooth locations in accordance with the Universal numbering system, a dental notation system commonly used in the United States and elsewhere. According to the site prioritization proposed by this invention, the most preferred location is the buccal pit in the facial surface of Tooth #30 (right lower first molar), followed by the buccal pit on the facial surface of Tooth #19 (left lower first molar). The buccal pit of Tooth #30 and Tooth #19 are desirable locations because each bears an inherent enamel defect and uncoalesced enamel, which is commonly filled as a preventative measure to ward off the development of a dental cavity. Other prioritized sites of this invention include the lingual groove in the lingual surface of Tooth #3 (right upper first molar) or Tooth #14 (left upper first molar), which also bear an inherent enamel defect and uncoalesced enamel. Still other prioritized sites include the facial surface of Tooth #31 (right lower second molar) or Tooth #18 (left lower second molar), and the lingual surface of Tooth #2 (right upper second molar) or Tooth #15 (left upper second molar).

FIGS. 1A through 1E represent facial views showing steps of a procedure for implanting the tag 10 in the buccal pit of Tooth #30. As noted above, the buccal pit of Tooth #30 is the primary location, with the buccal pit of Tooth #19 being an alterative primary location if implantation in Tooth #30 is not possible. Those skilled in the art of dentistry will be aware that the presentation and steps for implantation in Tooth #19 would be the mirror image of that shown in FIGS. 1A-1E.

FIG. 1A represents Tooth #30 prior to placement of the tag 10. In FIG. 1B, the tooth has been prepared for implantation by creating a cavitation 30 at the buccal pit of the tooth. The cavitation 30 can be formed using standard dentistry procedures, and therefore will not be discussed in any detail here. Suitable dimensions for the cavitation 30 are a length (mesial-distal) of up to 7 mm (preferably 5 to 7 mm), a width (occlusal-cervical) of up to 2 mm, and a depth (pulpally) of up to 4 mm (preferably 2 to 4 mm). With these dimensions, tooth preparation can be completed with or without anesthetization. The horizontal orientation of the cavitation 30 is preferred. A vertical orientation using the same cavitation dimensions could be used, though doing so is not preferred or recommended. The enamel margins of the cavitation 30 are preferably beveled, such as by using a carbide or diamond bur. Preparation is best completed by conventional equipment such as a highspeed handpiece (air or electric driven) and a 330 and 57 carbide bur, but air abrasion, waterlase, and dental laser are also options.

Following rinsing and drying to remove debris, a standard acid etch and bond is performed. Any conventional acid etch and bond technique can be used, though a one-component light-cured self-etched/self-priming dental adhesive is preferred. Alternatively, a separate etch and bond could be performed, in which case it is necessary that all etchant is remove by a water rinse. Suitable self-etching/self-bonding dental adhesives are known to contain mono-, di- or trimethacrylate resins, dipenta-crythritol penta acrylate monophosphate, photo-initiators, stabilizers, water acetone, and cetyl amine hydrofluoride. All tooth surfaces are preferably scrubbed with generous amounts of the adhesive for about fifteen to twenty seconds to thoroughly wet all tooth surfaces. This procedure is then repeated, after which excess adhesive is removed and the remainder dried for about five to ten seconds with clean dry air. Cure can then be accomplished by subjecting the adhesive to light for about ten seconds.

If a separate etch and bond technique is used, the etchant may contain a phosphoric acid concentration of 35 to 50% in solution or gel. A treatment of about thirty to sixty seconds is appropriate, followed by rinsing and drying without dessication for about fifteen seconds. The bonding agent preferably contains a sulfur-based amine activator within an ethyl alcohol solvent. The use of a hydrochloric or hydrofluoric acid etch is not recommended due to the risk that the tag 10 might be attacked by these acids at high concentrations.

FIG. 1C depicts the result of placing a bed 32 of flowable resin in the cavitation 30, for example, to a depth of about 0.5 to about 1 mm. A suitable resin material is a light-curable microfill resin paste containing BIS-GMA polymerizable dimethacrylic resin, strontium or barium aluminum fluorosilicate glass, low dispersed silica, ammonium salt of dipentaerythitol penta-acrylate phosphate and mixed oxide conventional catalysts and stabilizers. FIG. 1D shows the placement of the tag 10 on the resin bed 32, after which the resin bed 32 undergoes curing for a duration sufficient to fully set the resin. The bed 32 of flowable resin is placed to not only secure the tag 10, but to ensure the dental pulp is insulated and protected. The bonded flowable resin bed 32 also ensures the dentinal tubules are completely sealed, ensuring that the tag 10 is ultimately imbedded in resin and does not intimately contact the tooth.

FIG. 1E shows the completed Tooth #30 after filling with a dental restoration 34 formed with a posterior composite resin to close the cavitation 30 and the tag 10 therein. The composite resin is preferably a delicate, void-free microfill (small particulate size) composite resin containing a pyrogenic silica filler with a particle size of less than one micrometer, such as on the order of about 0.04 micrometer. A microfill posterior composite resin is preferred for final filling of the cavitation 30 because it's condensation ability allows for the application of a firm pressure to deliver the resin totally around the exposed portion of the tag 10, as well as to conform to all regions of the cavitation 30. Microfill posterior composite resins are preferred over traditional macrofill (large particulate size) posterior composite resins because the latter contain filler particles such as quartz or boron glass with a particle size on the order of about 1 to 20 micrometers. Though it may be possible to condense into the cavitation 30, macrofill composite resins increase the chance of internal voids in the vicinity of the tag 10, and lower polishability.

The composite resin undergoes curing until a full set is confirmed, after which the restoration 34 is polished. Armamentarium for finishing the final restoration 34 includes fine grit diamond, 12 to 20 bladed carbide burs, tapered or round stones, finishing strips and disks, rubber cups and a resin glaze.

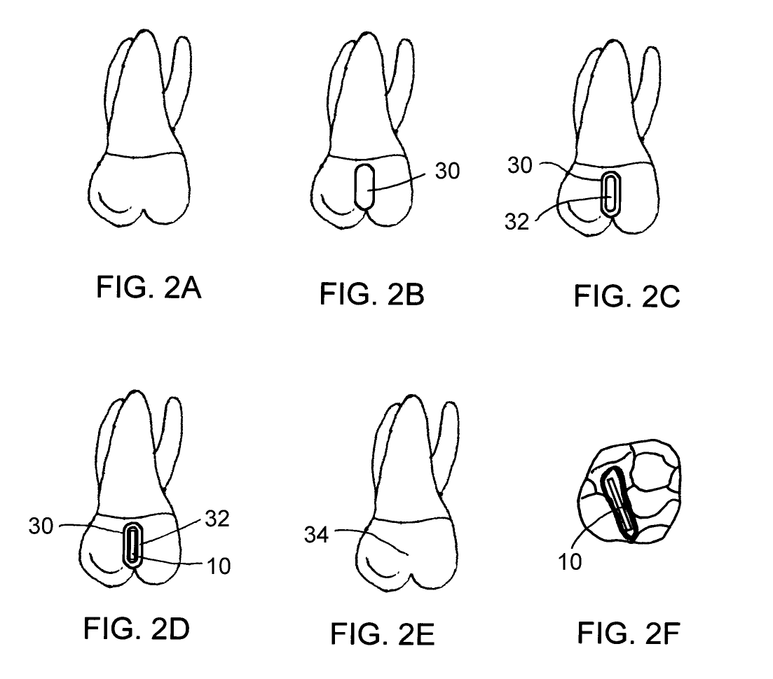

FIGS. 2A through 2E represent lingual views showing the procedure for implanting the tag 10 in the secondary location, namely, the lingual groove of Tooth #3. (The presentation and steps for implantation in alternative secondary location Tooth #14 would be the mirror image of that shown in FIGS. 2A-2E.) Other than the cavitation 30 being vertically oriented as represented in FIG. 2B, the procedure is essentially identical to that explained above for Tooth #30 and #19 in reference to FIGS. 1A-1E. For clarity, FIG. 2F is an occlusal (top) view of the implanted tag 10 in Tooth #3.

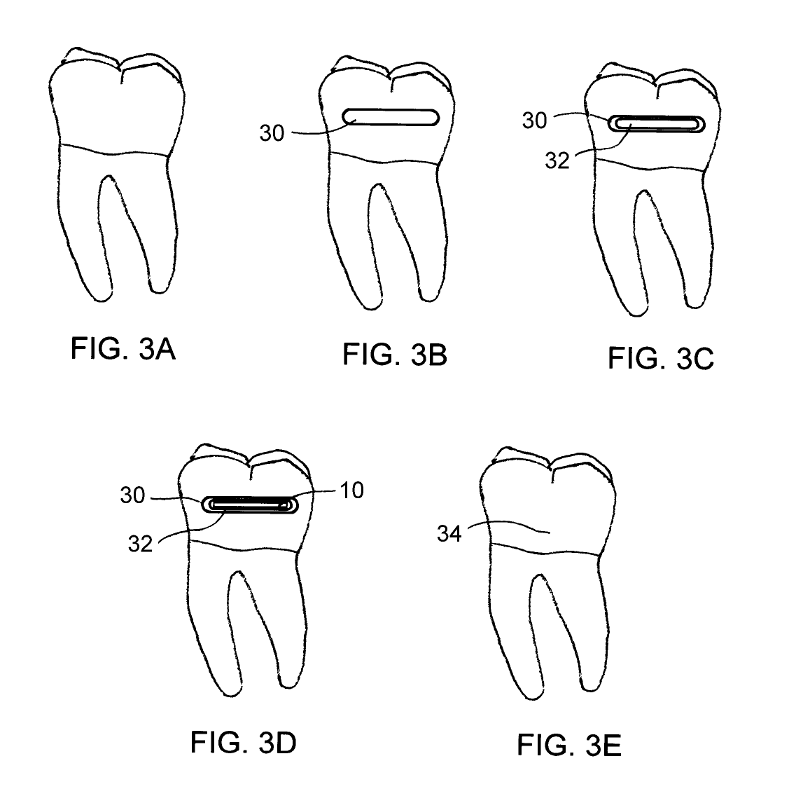

FIGS. 3A through 3E represent facial views showing the procedure for implanting the tag 10 in the tertiary location, namely, the facial surface of Tooth #31. (The presentation and steps for implantation in alternative tertiary location Tooth #18 would be the mirror image of that shown in FIGS. 3A-3E.) The procedure is essentially identical to that explained above for Tooth #30 and #19.

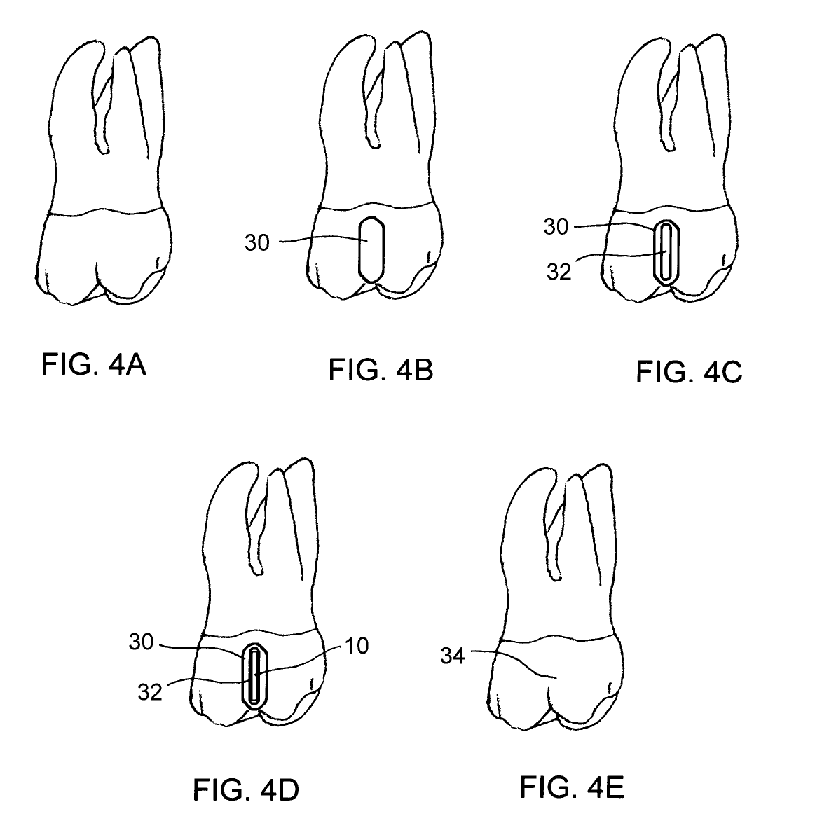

FIGS. 4A through 4E represent lingual views showing the procedure for implanting the tag 10 in the quaternary location, namely, the lingual surface of Tooth #2. (The presentation and steps for implantation in alternative secondary location Tooth #15 would be the mirror image of that shown in FIGS. 2A-2E.) Other than the cavitation 30 being vertically oriented as represented in FIG. 4B, the procedure is essentially identical to that explained above for Tooth #30 and #19.

The tag 10 can also be placed in complete or partial dentures (not shown). If placed in a complete maxillary denture, the tag 10 can be placed into the facial surface of the right posterior flange apical to the distal buccal root of Tooth #3. If placed in a complete mandibular denture, the tag 10 may be placed into the facial surface of the right posterior flange apical to the distal root of Tooth #30. Secondary locations are the Tooth #14 or #19 buccal flanges, and tertiary locations are at palatal or lingual locations of the same tooth numbers. If the tag 10 is to be placed in removable maxillary partial dentures, preferred primary locations are the same as those of a maxillary complete denture. Secondary locations include placement into the facial surface of the right posterior flange apical to the most distal tooth's distal root. Tertiary locations include placement into the facial surface of the left posterior flange apical to the most distal tooth distal's root. Finally, quaternary locations include placement on the facial flange in an area that will accommodate the size and depth requirements for tag 10 (e.g., dimensions similar to those identified for the cavitation 30).

The tag 10 can also be placed in a removable dental prosthesis (not shown). For this purpose, a surface region of the prosthetic material (typically an acrylic) is removed with a round bur or other suitable tool at one of the priority locations set forth for implantation of the tag 10 in a tooth. The resulting void is then cleaned, rinsed, dried, and conditioned to accept new acrylic. After activation of the tag 10 is verified with a reader unit, the mesial and distal ends of the tag 10 are tacked into place within the void using an adhesive, such as a cold cure resin. After drying, the remaining void is filled with an adhesive, such as a cold cure acrylic, which is polished after curing. Preferred locations and prosthetics for the tag 10 include those corresponding to the prioritized sites for natural teeth as described above.

The tag 10 can be programmed before or after placement. As previously noted, programming generally entails storing on the tag 10 a unique identification number, and preferably coding associated with other pertinent information, such as the medical history of the individual. Once programmed and placed in accordance with one of the forgoing implantation procedures, the functionality of the tag 10 should be confirmed with a reader unit. The identification number associated with the tag 10 and other pertinent information can then be downloaded for storage in a secure database, for example, in a computer with software with which the reader unit communicates, such as through a USB jack. Depending on the circumstances, the individual may be provided with a printout of the contents of their record stored in the database. Also depending on the purpose of the implantation and the availability of appropriate systems, the individual's identification may be included in a database accessible by certain individuals, such as healthcare providers, and particularly dentistry professionals who in the normal course of a dental examination can verify the identity of a patient, including whether a child patient is listed in a missing child database, and/or the medical history of the patient. Alternatives include identifying military personnel, and use when traveling such as to confirm the individual's identify at military facilities, airport security checks, customs checkpoints, etc.

Once correctly placed by a dental professional, the tag 10 will not migrate and cannot be altered or lost, nor can the tag 10 be readily detected without appropriate equipment capable of communicating with or otherwise sensing the tag 10. For example, an individual can be equipped with the tag 10 without the telltale bump associated with a subdermally implanted RFID chip. An additional feature of the invention is the ability to remove the tag 10 without injuring or scarring the individual. For example, if the individual is a child, he or she may choose to remove the tag 10 once he or she reaches adulthood. Likewise, if the individual is a military personnel, the tag 10 may be removed once he or she is discharged from military service. The tag 10 can generally be removed with a round bur or any other suitable dental tool, and the resulting cavitation repaired by restoration procedures commonly used in dentistry practices.

While the invention has been described in terms of specific embodiments, it is apparent that other forms could be adopted by one skilled in the art. For example, the physical configuration of the tag 10 could differ from that described, and a wide variety of dentistry materials and procedures are known by dentistry professionals and could be used in place of for those materials and procedures noted. Therefore, the scope of the invention is to be limited only by the following claims.

1. A method of identifying a human with an electronic identification transponder that can be interrogated by and communicate with a reader unit, the method comprising implanting the electronic identification transponder in a surface region of a dental structure chosen from the group consisting of mammalian teeth, dentures, and dental prostheses.

2. The method according to claim 1, wherein the electronic identification transponder comprises a radio frequency identification chip.

3. The method according to claim 1, wherein the radio frequency identification chip is on a substrate and connected to an antennae on the substrate.

4. The method according to claim 1, wherein the dental structure is a mammalian tooth, and the method further comprises forming a cavitation in the tooth, placing a flowable resin in the cavitation, placing the electronic identification transponder in the flowable resin within the cavitation, and filling the cavitation to restore the original outer appearance of the tooth.

5. The method according to claim 4, wherein the cavitation has dimensions of up to about 4 millimeters in depth and up to about 7 millimeters in length.

6. The method according to claim 4, wherein the surface region of the tooth is a facial, lingual, or occlusal surface of the tooth.

7. The method according to claim 4, wherein the tooth is either Tooth #31 or Tooth #19, and the surface region contains the buccal pit on the facial surface of the tooth.

8. The method according to claim 4, wherein the tooth is either Tooth #3 or Tooth #14, and the surface region contains the lingual groove in the lingual surface of the tooth.

9. The method according to claim 4, wherein the tooth is either Tooth #31 or Tooth #18, and the surface region is on the facial surface of the tooth.

10. The method according to claim 4, wherein the tooth is either Tooth #2 or Tooth #15, and the surface region is on the lingual surface of the tooth.

11. The method according to claim 4, wherein the flowable resin prevents intimate contact between the electronic identification transponder and the tooth, insulates and protects the dental pulp of the tooth, and seals the dentinal tubules of the tooth.

12. The method according to claim 4, wherein the cavitation is filled with a microfill resin.

13. The method according to claim 12, wherein the microfill resin contains a particulate filler having a particle size of less than one micrometer.

14. The method according to claim 1, wherein the dental structure is a denture.

15. The method according to claim 1, wherein the dental structure is a dental prosthesis, and the method further comprises forming a void in the dental prosthesis, placing the electronic identification transponder in the void, and filling the void to restore the original outer appearance of the dental prosthesis.

16. The method according to claim 1, further comprising the steps of using the reader unit to interrogate and communicate with the electronic identification transponder.

17. The method according to claim 16, further comprising the step of programming the electronic identification transponder to contain additional information pertaining to the human.

18. The method according to claim 16, further comprising the steps of:
programming the electronic identification transponder to have an identification number;
using the reader unit to interrogate the electronic identification transponder and read the identification number of the electronic identification transponder; and
using the reader unit to store additional information pertaining to the human.

19. The method according to claim 18, further comprising the step of storing the identification number and the additional information in a database separate from the electronic identification transponder.

20. The method according to claim 19, wherein the database is accessible to healthcare providers.
